(19) United States
(12) Patent Application Publication
(10) Pub. No.: US 2013/0025800 A1
(43) Pub. Date: Jan. 31, 2013

(54) ROLLER SHUTTER SYSTEM FOR A MOTOR VEHICLE BODY

(71) Applicants: Florian Kiesenhofer, St. Leonhard bei Freistadt (AT); Alexander Ronacher, Hoersching (AT); Bernhard Stadler, Oberkappel (AT)

(72) Inventors: Florian Kiesenhofer, St. Leonhard bei Freistadt (AT); Alexander Ronacher, Hoersching (AT); Bernhard Stadler, Oberkappel (AT)

(73) Assignee: ROSENBAUER INTERNATIONAL AKTIENGESELLSCHAFT, Leonding (AT)

(21) Appl. No.: 13/640,335

(22) PCT Filed: May 5, 2011
(86) PCT No.: PCT/AT2011/000215

§ 371 Date: Oct. 10, 2012

(30) Foreign Application Priority Data
May 6, 2010 (AT) A 761/2010

(51) Int. Cl. B60J 5/08; E06B 9/11

(52) U.S. Cl. 160/133

(57) ABSTRACT

The invention relates to a roller shutter system for a motor vehicle body, in particular for a fire brigade vehicle, with a roller shutter armor (26) formed by slats (25) connected in an articulated manner to one another. Guide arrangements (27) extend on both sides of the roller shutter armor (26) between a floor virtually as far as a ceiling of a machine body. The roller shutter armor (26) is provided with an opening and locking device on an end slat facing the floor. The guide arrangement (27) is formed by a first guide profile (34) which is connected to the machine body and forms at least one guide track (51). A further guide profile (52) is detachably connected to the first guide profile (34). An end profile (65) which, by means of at least one elastic sealing lip (68), covers an end region of the slats (25), is arranged on the further guide profile (52).

The invention relates to a roller shutter system as described in the preamble of claim 1.

From document DE 20 2006 010 974 U1, an emergency service vehicle, in particular a fire engine, having a vehicle body, at least one roller shutter system is assigned to, is known. This emergency service vehicle has at least one roller shutter armor which can be adjusted between a closing position closing an opening of the vehicle body and at least one opening position and is designed as a shutter module which is attached to at least one outer face of the vehicle body and fastened by means of fastening means.

From a further document, DE 100 60 345 A1, a guiding device for roller shutters or suchlike is known. A guiding rail for the roller shutter has an essentially U-shaped cross section. The guiding rail is embodied in such a way that at least one of the legs forming the U-shaped cross section can be swiveled from a first position, where the roller shutter is adjustably guided between the two les of the guiding rail, into a second position, where the roller shutter in its stretched arrangement can be inserted into the guiding rail or can be withdrawn from the guiding rail.

Finally, document DE 103 13 429 A1 discloses a roller shutter device for emergency service vehicles, in particular fire engines, a roller shutter locking of which can be operated by means of a lift rod disposed in swivel bearings at the roller shutters and the roller shutters of which is secured against opening and in a roller shutter slat, at least one locking bar element is disposed in longitudinal direction of the slat and can be adjusted by means of a swivel movement of the lift hub.

The underlying objective of the invention is to provide a roller shutter system having a roller shutter armor for a vehicle body, which can be integrated flush in walls bordering the vehicle body.

The objective of the invention is achieved by the features described in the characterizing part of claim 1. In this case, the surprising advantage is that guiding tracks for guiding arrangements forming the roller shutter armor are directly mounted to the separator elements dividing the interior and guarantee a sealing as well as stabilizing connection of parts of the exterior wall with separator elements at simplifying the mounting effort.

In this case, embodiments according to the claims 2 and 3 are advantageous, with the result that roller shutter systems can be integrated adjoining one another in exterior walls as well as directly adjacent to front and end walls.

Also advantageous are the embodiments according to claims 4 and 5, since thus the positioning and fastening of the guide profile at the vehicle body in combination with a further guide profile is achieved and the mounting of the roller shutter armor is substantially simplified.

According to the advantageous embodiment as described in claim 6, a high torsional stiffness of the guide profiles is achieved.

By the advantageous embodiments as described in claims 7 and 8, additional fitting aids are omitted.

The advantageous embodiments according to claims 9 and 10 guarantee a low sliding friction, with the result that the roller shutter armor slides smoothly within the guide arrangements.

The advantageous embodiment as described in claim 11 effects a high abrasion resistance of the covering profile forming the exterior end.

Advantageous are sealing lips at the covering profile, with the result that a dust- and moisture-proof connection to the roller shutter armor is achieved.

Also advantageous is however an opening and closing device according to claims 13 to 15, with the result that a safe closing of the operating opening of the vehicle body is achieved and a simple and fast operability and consequently accessibility to the interior of the vehicle body is ensured in individual cases.

For a better understanding, the invention will be explained in more detail below according to the figures shown in the drawings.

The heavily simplified schematics show:

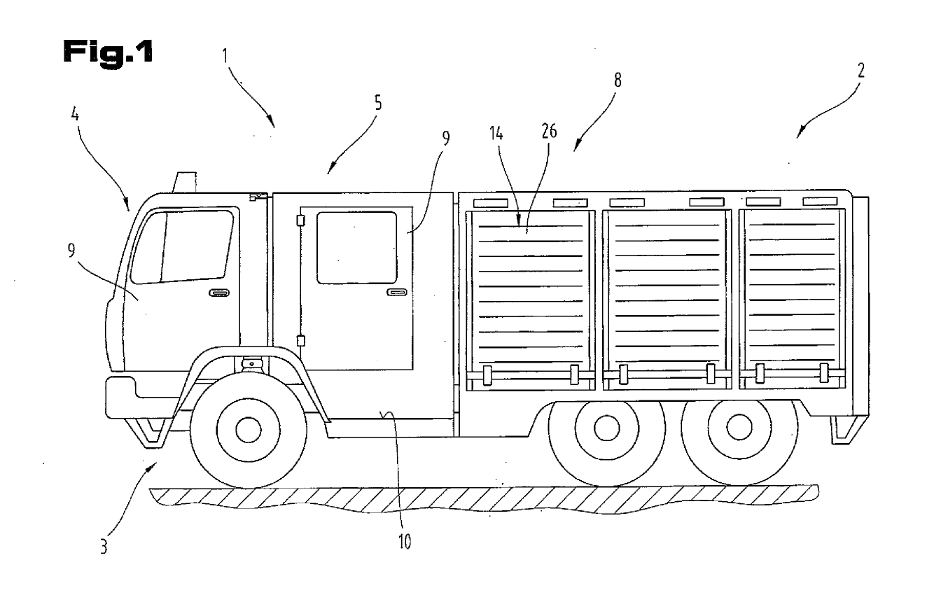

FIG. 1 a simplified illustration of a motor vehicle having a roller shutter system according to the invention;

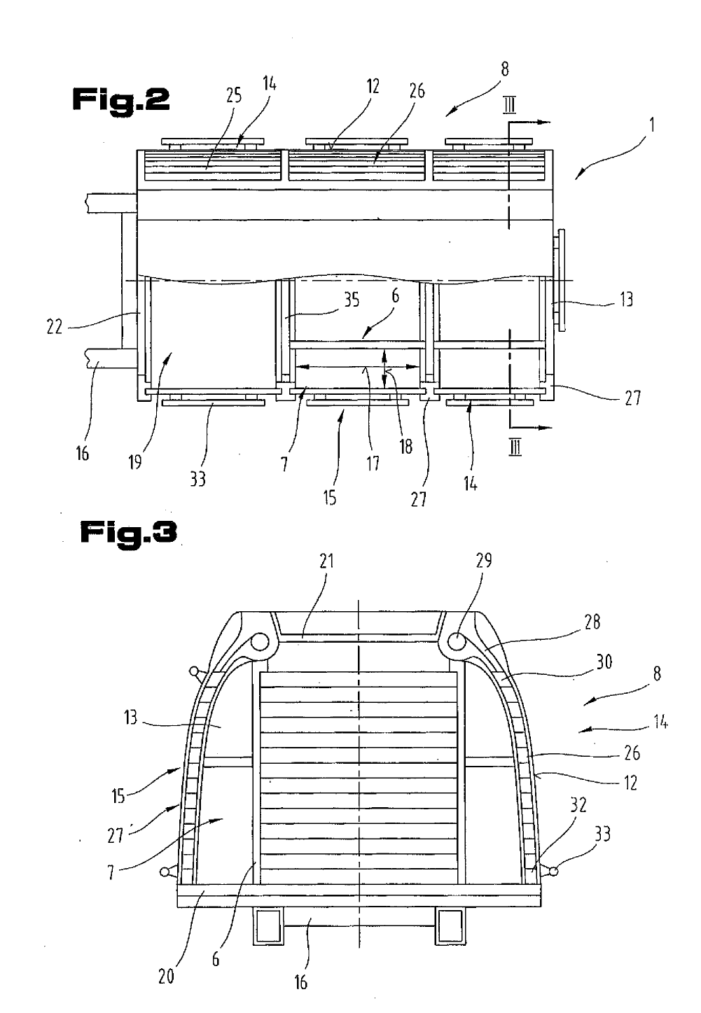

FIG. 2 a machine body having the roller shutter system according to the invention in top view, partially in sectional view;

FIG. 3 the machine body in sectional view according to the lines III in FIG. 2;

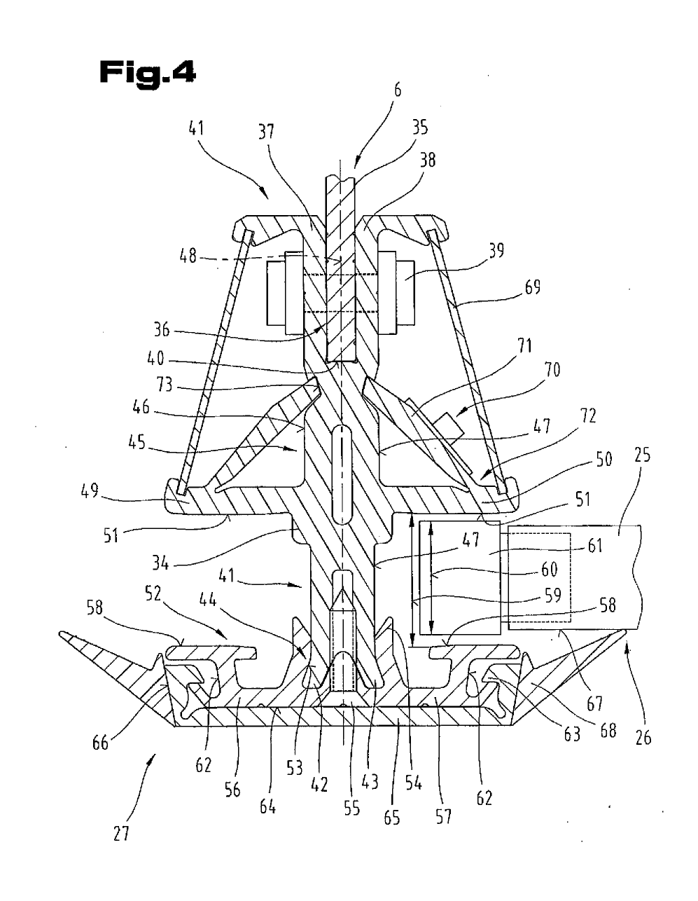

FIG. 4 a guide arrangement of the roller shutter system according to the invention in sectional view;

FIG. 5 another embodiment of the guide arrangement of the roller shutter system according to the invention, in sectional view;

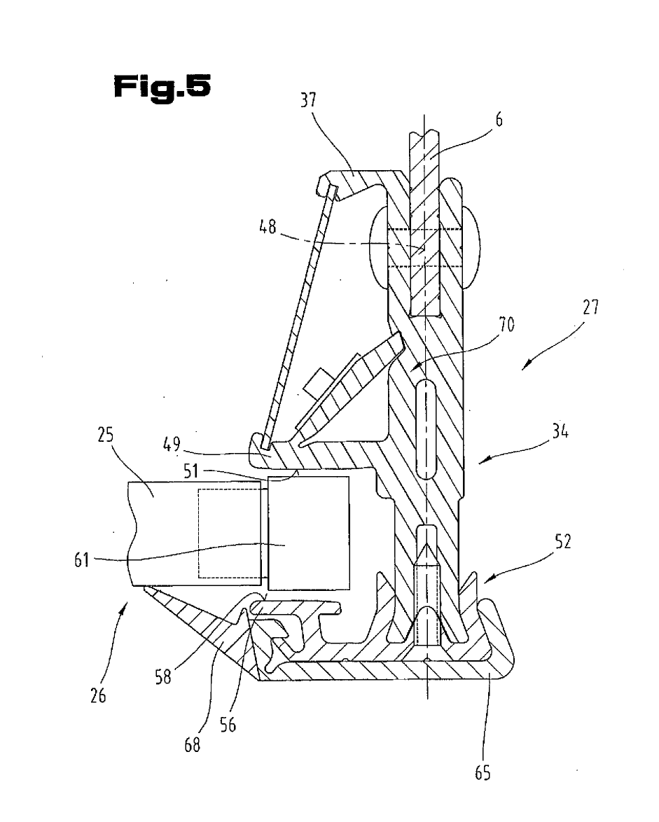

FIG. 6 a deflection element of the roller shutter system according to the invention, partially in sectional view;

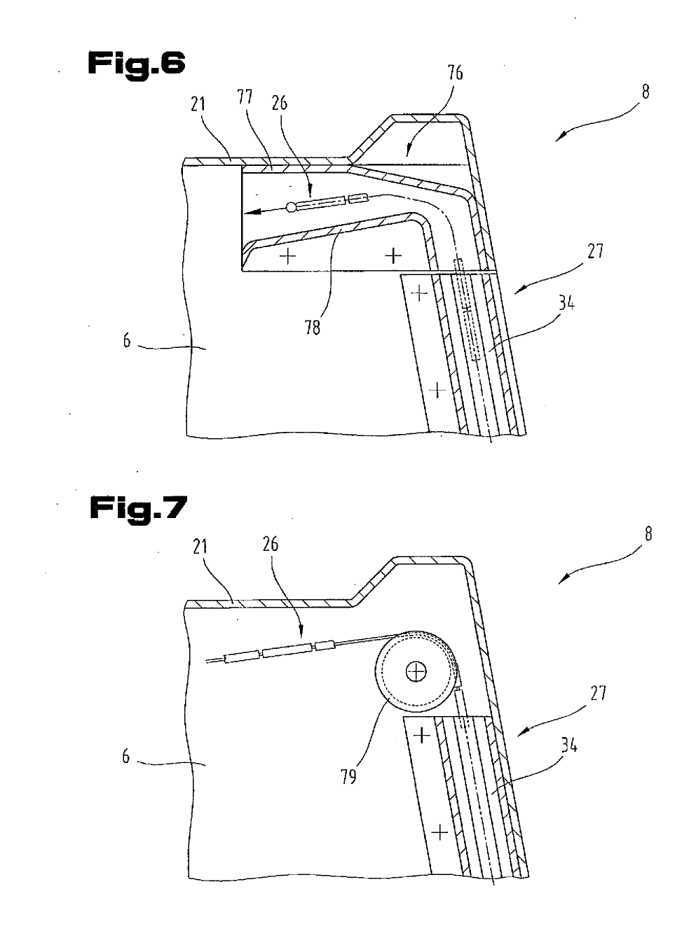

FIG. 7 another embodiment of a deflection element of the roller shutter system according to the invention, partially in sectional view;

FIG. 8 the roller shutter system having an opening and closing device in view;

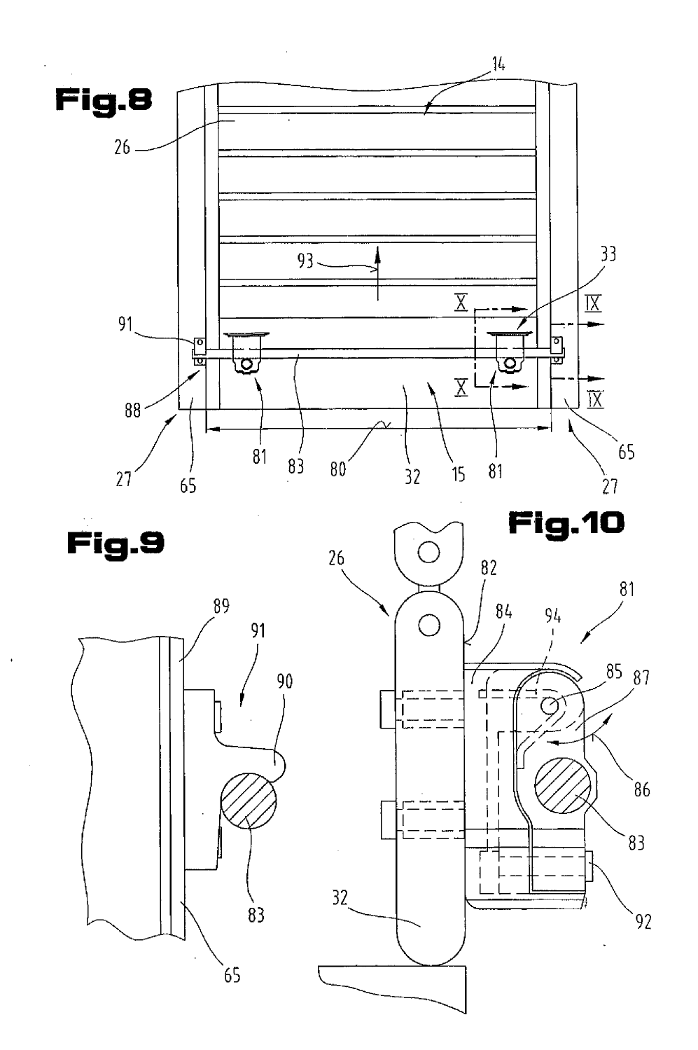

FIG. 9 the opening and closing device in sectional view according to the lines IX-IX in FIG. 8;

FIG. 10 the opening and closing device of the roller shutter system according to the invention in sectional view according to the lines X-X in FIG. 8.

It must first be stated that in the various embodiments described, identical parts have been marked with the same reference identifiers and the same parts descriptions. It is therefore possible to transfer the disclosures contained in the overall description to the identical parts with the same reference identifiers or the same parts descriptions. The selected positioning terms are used in the description, such as top, bottom, side etc., which refer directly to the described and the depicted figures and which can be correspondingly transferred to the new position in the event of a change in position. Furthermore, individual characteristics or combinations of characteristics from the various embodiments shown and described can present independent or inventive solutions, or solutions according to the present invention.

All value range specifications in the objective description should be taken as arbitrary ranges which encompass all subareas lying within these ranges, e.g. the specification 1 to 10 should be understood to encompass the full range starting from the bottom limit 1 and rising to the top limit 10, i.e. all subareas start with a bottom limit of 1 or more and end with a top limit of 10 or less, e.g. 1 to 1.7, or 3.2 to 8.1, or 5.5 to 10.

FIG. 1 shows a truck 1, in particular a fire brigade vehicle 2. According to the shown exemplary embodiment, a driver's cabin 4, a team's cabin 5 and a box-like machine body 8, preferably being divided into compartments 7 of different sizes by separator elements 6, are disposed on a chassis 3.

There is no need to go into the details of the equipment of the truck 1, as they belong to the scope of equipment in terms of driving operation, receipt of persons, equipment and tools required for an aid mission, since this equipment represents a matter of course with respect to respective purpose of operation of the truck 1 and is adapted to the respective requirements and specifications of the emergency personnel.

Doors 9 as well as means for getting in and off 10, e.g. step boards, stairs, ladders etc., for the driver's cabin 4, team's cabin 5 as well as opening closures 10 of the machine body 8 are in this case essential for a fast operational readiness of the truck 1 as well as the operation by the emergency personnel as well as the access to the equipment.

According to the exemplary embodiment shown, the machine body 8 has at least at one lateral wall 12 and/or one rear wall 13 preferably several opening closures 11 that are independent from each other and can be actuated and which opening closures 11 are formed from roller shutter systems 14 which are approximately flush integrated in the lateral wall 12 and/or rear wall 13.

These provide the advantage that large-area operating openings 15 of the machine body 8 are achieved, which operating openings 15 extend across one or several compartments 7 without the truck having disruptive contours which constrain the movement of the emergency personnel and furthermore roller shutter systems 14 of this kind ensure a fast access to the individual compartments 7.

FIGS. 2 and 3 show a detailed possible embodiment of the machine body 8 which is attached and fastened to the vehicle frame 16 by means of not shown damping and fastening means.

The box-like machine body 8 has an interior 19 divided into the compartments 7 having different widths 17 and depths 18. The interior 19 is bordered by a floor 20 and a ceiling 21, an end wall 22 and the rear wall 13. Generally, the embodiment of the machine body 8 with the separator elements 6 corresponds to a rib construction and, depending on a required equipping with tools and equipment, compartments 7 of different dimensions are achieved this way.

According to the shown exemplary embodiment, the machine body 8 has a number of operating openings 15, preferably in the lateral wall 12 extending in an arch-shaped way from the floor 20 to the ceiling 21, which operating openings 15 can be closed by the roller shutter systems 14. It is furthermore possible to provide an operating opening 15 in the rear wall 13 of the machine body 8 that can be closed by the roller shutter system 14.

The operating system 14 comprises a guide arrangement 27 for the slats 25 which is formed by slats 25 connected in articulated manner, extending in parallel direction to the floor and limiting the operating opening 15 on both sides of the roller shutter armor 26. Furthermore, in the region of the ceiling 21, there are deflection guides 28 and a spring-preloaded winding shaft 29 which is connected to an upper end slat 30 of the roller shutter armor 26 via flexible elastic traction means 31, e.g. belts, ropes etc. At an end slat 32 facing the floor, an opening and closing device 33 is provided, as it will be described in detail below.

In FIG. 4, a guide arrangement 27 is shown, which is designed for two directly adjacent roller shutter armors 26. It includes a first guide profile 34 which is connected to the separator element 6, e.g. a transverse wall 35 dividing the interior, with the guide profile 34 receiving an edge region 36 on the end wall of the transverse wall 35 between two legs 37, 38 and being fastened by means of fastening means 39, e.g. screws, rivets etc., sticking out the transverse wall 35 and the legs 37, 38.

The guide profile 34, which essentially protrudes an end face 40 of the transverse wall 33, at a further end region 41 being opposite the legs 37, 38 of an end region 41, has further legs 42, 43 extending parallel to each other the ends of which form an edge region being extended in a conical way. A connection bar 45, connecting the opposite edge regions 41 is provided with guiding rails 49, 50 projecting opposite the lateral walls 46, 47 and in perpendicular direction to a central plane 48, extending across the total length of the guide profile 34. These form guide tracks extending across the total length of the guide profile 34 for bearing the roller shutter armor being provided directly adjacent, i.e. the profile design with the guiding rails 49, 50 and the legs 37, 38, 42, 43 is formed symmetrically with respect to the central plane.

The first guide profile 34 is preferably made of plastics, in particular PVC—hard and is sufficiently elastic in order to adapt to the preferably bow-shaped end face 40—extending approximately with a 17 meter radius—of the transverse wall 35 when being mounted. Of course, also other, sufficiently elastic adaptable materials come into consideration.

By means of a resilient separation effect, a further guide profile 52, which has a holding groove 53 facing the legs 42, 43 of the first guide profile 34, is fastened on the legs 42, 43 of the first guide profile 34. This being the case, the holding groove 53 is formed by retaining edge 54 extending across the total length of the guide profile 52 symmetrically with respect to the center plane 48. In addition, for fastening the further guide profile 52 fastening screws 55 are provided across the total length at a distance in longitudinal direction of the center plane 48, which fastening screws 55 have an additional separation effect on the legs 42, 43 of the first guide profile 34 and consequently ensure a safe holding for the further guide profile 52. Starting at the center region of the guide profile 52 with the retaining edges 54, guide legs 56, 57 extend perpendicularly to the center plane 48 in symmetrical arrangement and embodiment, which guide legs 56, 57 face the guide rails 49, 50 of the first guide profile 34 and form guide tracks 58 for the roller shutter armor 26 which run parallel to the guide tracks 51 of the first guide profile 34.

A distance 59 between the first guide profile 34 and the guide tracks 58 of the second guide profile 52 is slightly larger than a width 60 of slide blocks 61, which are arranged in the end regions of the slats 25 of the roller shutter armor 26 as traction means, mad of a material having a low coefficient of friction.

This further guide profile 52 is preferably made of light metal, in particular AL-alloy and has, compared to the first guide profile 34 that due to its cross-section has a high section modulus around an axis extending perpendicularly to a center plane 48, a low section modulus, with the result that it can be adjusted to the bow-shaped curvature of the lateral wall even if it is made of metal. In this case, the advantage is the low coefficient of friction of the material with the result that the roller shutter armor 26 having a slide block 61 slides well.

The guide legs 56, 57 of the further guide profile 52 have snap-in grooves 62 at their lateral regions, which snap-in grooves 62 extend across the total length of the guide profile 52. These snap-in grooves 62 serve for engaging holding beads 63 of an end profile 65 which can be attached and cover an upper side 64 and thus the fastening screws 55, which end profile 65 is preferably made of hard-PVC or comparable adjustable materials and that is disposed at opposite lateral surfaces 66 of sealing lips 68 protruding in the direction of a surface 67 of the roller shutter armors 26 and bearing against the slats 25 which sealing lips 68 are preferably extruded to the end profile 65. They are preferably made of a very elastic material, e.g. TPE or another material similarly well sealing and having a low coefficient of friction.

As it can furthermore be taken from FIG. 4, by grooves that are disposed opposite one another, the profiling of the guide profile 34 allows providing preferred transparent covering strips 69 that can be inserted into the legs 37, 38 and guide profiles 49, 50 thus providing protected holding areas for LED-light strips 70 for illuminating the adjacent compartments. These can particularly be mounted to carrier strips 71 which are extruded to the guide legs 49, 50, and the carrier strips 71, by the embodiment of a weakened zone 72, are put from their basic position which is required for the extrusion process and are engaged into a holding bead 63 provided in the connection bar 45 of the guide profile 34 for stabilization before or after the Led-light strips 70 are mounted.

FIG. 5 shows another embodiment of the guide arrangement 27 fastened to the separator element 6. These guide arrangements 27 are made of a first guide profile 34 which is embodied asymmetrically with respect to the center plane 48, asymmetrical further guide profile 52 and asymmetrically embodied end profile 65 having a sealing lip 68 which is disposed at one side.

This embodiment forms a unilateral guide arrangement 27 for a roller shutter armor 26 which no further one is assigned to adjacently.

This being the case, this guide arrangement 27 is embodied as described with respect to FIG. 4, at remaining embodiment with respect to only one guide track 51 for sliding accommodation of the slide block 61 inserted into the slat 25 being equal.

It is provided to apply this guide arrangement 27 being embodied with respect to the guide alignment for the roller shutter armor 26 at separator elements 6, in particular at end- or rear walls of the machine body 8.

FIG. 6 shows the deflection element 76, by means of which the roller shutter armor 26 is guided from the approximately vertical extending direction of adjustment to approximately horizontally extending direction. It is preferably formed from a plastics molded part and has two bow-shaped guiding rails 77, 78 extending parallel at a distance, between which the roller shutter armor 26 is guided in direction of a not shown spring-preloaded winding shaft. The guiding rails 77, 78 are disposed at a supporting plate and protrude the supporting plate for sliding accommodating the slide blocks provided in the slats in the direction of the roller shutter armor 26. Preferably, the deflection elements 76 are integrally formed from plastics with the guiding rails 77, 78, in order to apply only a low frictional resistance to adjustment.

FIG. 7 shows another embodiment of the deflection element 76. According to this embodiment, a deflection pulley 79 which is pivoted about an axis perpendicular to the adjustment direction of the roller shutter armor 26 is disposed in the region of the ceiling 21 and subsequent to the guide profile 34.

FIGS. 8 to 10 show a possible embodiment of the opening and closing device 33 of the roller shutter system 14.

It includes at least two fittings 81 which are arranged at a distance from each other on the end slat 32 of the roller shutter armor 26 in direction of a width of shutter 80 and which fittings 81 are probably embodied to be lockable and hold a grab bar 83 at the outer face 82 of the end slat 32 in a raised way.

The fittings 81 are essentially made of a base part 84 being attached to the end slat 32 and a housing part 87 being pivoted—according to double arrow 86—about an swivel axis 85 extending parallel to the outer face 82 of the base part 84 which housing part 87 incorporates the grab bar 83, e.g. a tube or a round rod of metal, in a bore.

The grab bar 83 protrudes the width of shutter 80 on both sides, with the end regions 88 at least sectional covering the end profiles 65 of the guide arrangement 27 for the roller shutter armor 26.

On a surface 89 of the end profiles 65 locking bar elements 91 by means of retaining lugs 90, which locking bar elements 91 protrude sections of the grab bar at an upper side when the roller shutter armor 26 is in its closed state.

The opening of the roller shutter armor 26 is effected by swiveling the housing parts 87 of the fittings 81 by operating the grab bar 83, with the result that they are taken off the region of the retaining lugs 90 and the roller shutter armor 26, supported by the spring-preloaded winding shaft, is shifted for releasing the operating opening 15.

At least one fitting 81 per roller shutter armor 26 is equipped with one blocking lock 92 that can be operated by means of a key. It is disposed in the housing part 87 that can be swiveled and effects in its locking position an interlocking with the base part 84.

This being the case, it is effectively prevented that the grab bar 83 swivels out of the region of the retaining lugs 87 and an abusive shifting of the roller shutter armor 26 into the opening direction—according to arrow 93—is impossible for unauthorized persons.

The housing parts 86 that can be swiveled are operatively connected to the base part 84 by means of return springs 94, with the effect that an automatic return of the housing parts 87 and consequently of the grab bar 83 into the closed position is effected when not being operated.

It is furthermore noted that in the event that the roller shutters have larger widths 80 it can be purposeful to provide them with more than the two shown fittings 81.

The materials described for the guides 34, 52, the end profile 65 and sealing lip 68 are only exemplary and naturally, also materials having similar mechanical characteristics can be used.

The exemplary embodiments refer to possible variants of embodiment of roller shutter system 14 are not intended to limit the scope of the invention to these illustrated variants of embodiments provided herein but that there are also various combinations among the variants of the embodiments themselves and variations regarding the present invention should be executed by a person skilled in the art. All and every imaginable variants of the embodiment, arising from combining single details of the variant of embodiment illustrated and described are subject to scope of protection.

As a matter of form, it is finally also noted that in order to facilitate an enhanced understanding of the design of the roller shutter system 14, the latter and its component parts are illustrated in part not to scale and/or enlarged and/or reduced in size.

The fundamental function of the independent inventive solutions can be taken from the description.

List of Reference Numerals

| | |
|---|---|
| 1 | Truck |
| 2 | Fire brigade vehicle |
| 3 | Chassis |
| 4 | Driver's cabin |
| 5 | Team's cabin |
| 6 | Separator element |
| 7 | Compartment |
| 8 | Machine body |
| 9 | Door |
| 10 | Means for getting in and off |
| 11 | Opening closure |
| 12 | Lateral wall |
| 13 | Rear wall |
| 14 | Roller shutter system |
| 15 | Operating opening |
| 16 | Vehicle frame |
| 17 | Width |
| 18 | Depth |
| 19 | Interior |
| 20 | Floor |
| 21 | Ceiling |
| 22 | End wall |
| 23 | |
| 24 | |
| 25 | Slat |
| 26 | Roller shutter armor |
| 27 | Guide arrangement |
| 28 | Deflection guide |
| 29 | Winding shaft |
| 30 | End slat |
| 31 | Traction means |
| 32 | Terminal slat |
| 33 | Opening and closing device |
| 34 | Guide profile |
| 35 | Transverse wall |
| 36 | Edge region |
| 37 | Leg |
| 38 | Leg |
| 39 | Fastening means |
| 40 | End face |
| 41 | Edge region |
| 42 | Leg |
| 43 | Leg |
| 44 | Edge region |
| 45 | Connection bar |
| 46 | Lateral surface |
| 47 | Lateral surface |
| 48 | Center plane |
| 49 | Guiding rail |
| 50 | Guiding rail |
| 51 | Guide track |
| 52 | Guide profile |
| 53 | Holding groove |
| 54 | Retaining edge |
| 55 | Fastening screw |
| 56 | Guide leg |
| 57 | Guide leg |
| 58 | Guide track |
| 59 | Distance |
| 60 | Width |
| 61 | Slide block |
| 62 | Snap-in groove |
| 63 | Holding bead |
| 64 | Upper side |
| 65 | End profile |
| 66 | Lateral surface |
| 67 | Surface |
| 68 | Sealing lip |
| 69 | Covering strip |
| 70 | LED-light strip |
| 71 | Carrier strips |
| 72 | Weakened zone |
| 73 | Retaining groove |
| 74 | |
| 75 | |
| 76 | Deflection element |
| 77 | Guiding rail |
| 78 | Guiding rail |
| 79 | Deflection pulley |
| 80 | Width of shutter |
| 81 | Fitting |
| 82 | Outer face |
| 83 | Grab bar |
| 84 | Base part |
| 85 | Swivel axis |
| 86 | Double arrow |
| 87 | Housing part |
| 88 | End region |
| 89 | Surface |
| 90 | Retaining lug |
| 91 | Locking bar element |
| 92 | Blocking Lock |
| 93 | Arrow |
| 94 | Return spring |

1. Roller shutter system (14) for a motor vehicle body, in particular for a fire brigade vehicle (2), with a roller shutter armor (26) formed by slats (25) connected in an articulated manner to one another with guide arrangements (27) extending on both sides of the roller shutter armor (26) between a floor (20) virtually as far as a ceiling (21) of a machine body and subsequent deflection elements (76) and with a winding shaft (29) being arranged after the deflection elements (76) in the region of the ceiling (21) and with an opening and locking device (33) on an end slat (32) facing the floor (20), wherein the guide arrangement (27) is formed by a first guide profile (34) which is connected to the machine body (8) and forms at least one guide track (51) and a further guide profile (52) that is detachably connected to the first guide profile (34), and an end profile (65) which, by means of at least one elastic sealing lip (68), covers an end region of the slats (25), is arranged on the further guide profile (52).

2. Roller shutter system (14) according to claim 1, wherein the guide profiles (34, 52) and the end profile (65) are embodied to be symmetrical with respect to a center plane (48).

3. Roller shutter system (14) according to claim 1, wherein the guide profiles (34, 52) and the end profile (65) are embodied to be asymmetrical with respect to a center plane (48).

4. Roller shutter system (14) according to claim 1, wherein the first guide profile (34) has a pair of legs (37, 38, 42, 43) being aligned parallel to one another and to the center plane at each opposite end region (41).

5. Roller shutter system (14) according to claim 4, wherein the legs (37, 38, 42, 43) have low distances to one another.

6. Roller shutter system (14) according to claim 1, wherein the guide tracks (51, 58) of the guide profiles (34, 52) are formed from guiding rails (49, 50) and guide legs (56, 57) that extend in a plane perpendicular to the center plane (48) and that have a distance (59) between one another.

7. Roller shutter system (14) according to claim 1, wherein the further guide profile (52) is detachably connected to the first guide profile (34) by means of retaining edges (54) forming a holding groove (53).

8. Roller shutter system (14) according to claim 1, wherein the end profile (65) is detachably connected to the further guide profile (52) by means of holding beads (63).

9. Roller shutter system (14) according to claim 1, wherein the first guide profile (34) is preferably made of plastics, e.g. hard-PVC.

10. Roller shutter system (14) according to claim 1, wherein the further guide profile (52) is preferably made of light metal, e.g. an AL-alloy.

11. Roller shutter system (14) according to claim 1, wherein the end profile (65) is preferably made of plastics, e.g. of hard-PVC.

12. Roller shutter system (14) according to claim 1, wherein the sealing lip (68) preferably integrally formed with the end profile (65) is made of plastics, e.g. of PET.

13. Roller shutter system (14) according to claim 1, wherein the opening and closing device (33) is formed by at least two fittings (81) being disposed at an end slat (32) of the roller shutter armor (26) and one grab bar (83) extending across at least a width of shutter (80).

14. Roller shutter system (14) according to claim 13, wherein the fittings (81) are formed by a base part (84) being fastened to an outer face (82) of the end slat (32) and a housing part (87) being disposed at a base part (84) in a pivoted way and holding the grab bar (83).

15. Roller shutter system (14) according to claim 14, wherein a lockable blocking lock (92) that can be locked by means of a key is disposed in the housing part (87).
